(19) United States
(12) Patent Application Publication
(10) Pub. No.: US 2022/0186786 A1
(43) Pub. Date: Jun. 16, 2022

(54) DOUBLE CARDAN JOINT

(71) Applicant: A.M.A. S.P.A., SAN MARTINO IN RIO (IT)

(72) Inventors: Marco ANGELONE, Casoli (IT); Marco NATALE, Casoli (IT)

(21) Appl. No.: 17/550,817

(22) Filed: Dec. 14, 2021

(30) Foreign Application Priority Data
Dec. 16, 2020 (IT) 102020000031067

(51) Int. Cl. F16D 3/33; F16D 3/84

(52) U.S. Cl. CPC F16D 3/33; F16D 3/845

(57) ABSTRACT

A double Cardan joint has a driving fork; a driven fork; a central body connected to the two forks by means of respective cross shafts; a first protection cap connected to the central body; and a second protection cap connected to the driven fork and coupled to the driven fork in a rotary manner so as to rotate, relative to the driven fork, around a rotation axis, which is transverse, in particular orthogonal, to a longitudinal axis of the driven fork.

### CROSS-REFERENCE TO RELATED APPLICATIONS

This Patent Application claims priority from Italian Patent Application No. 102020000031067 filed on Dec. 16, 2020, the entire disclosure of which is incorporated herein by reference in its entirety.

### TECHNICAL FIELD

The invention relates to a double Cardan joint.

### BACKGROUND ART

In particular, the invention relates to a double Cardan joint of the type comprising a driving fork, which is mounted so as to rotate around a longitudinal axis of its; a driven fork, which is mounted so as to rotate around a longitudinal axis of its; a central body, which is mounted so as to rotate around a longitudinal axis of its; a first cross shaft to connect the driving fork and the central body to one another; and a second cross shaft to connect the driven fork and the central body to one another.

The double Cardan joint further comprises a first protection cap connected to the central body; and a second protection cap connected to the driven fork.

The central body is engaged through the first protection cap in a rotary manner so as to rotate around its own longitudinal axis and the driven fork is engaged through the second protection cap in a rotary manner so as to rotate around its own longitudinal axis.

Known double Cardan joints of the type described above suffer from some drawbacks, which are mainly due to the fact that, in order to allow the driving fork, the driven fork and the central body to rotate around the relative cross shafts, the protection caps have a bellows configuration, are made of a flexible material and, hence, are subjected to a relatively great wear.

### DISCLOSURE OF INVENTION

The object of the invention is to provide a double Cardan joint that is not affected by the aforementioned drawbacks and can be manufactured in a simple and economic fashion.

According to the invention, there is provided a double Cardan joint as claimed in the appended claims.

### BRIEF DESCRIPTION OF THE DRAWINGS

The invention will now be described with reference to the accompanying drawings showing a non-limiting embodiment thereof, wherein:

FIGS. 1, 2, 3 and 4 are four schematic side views, with sectional parts and parts removed for greater clarity, of a preferred embodiment of the double Cardan joint according to the invention, which is shown in four different operating conditions.

### DETAILED DESCRIPTION

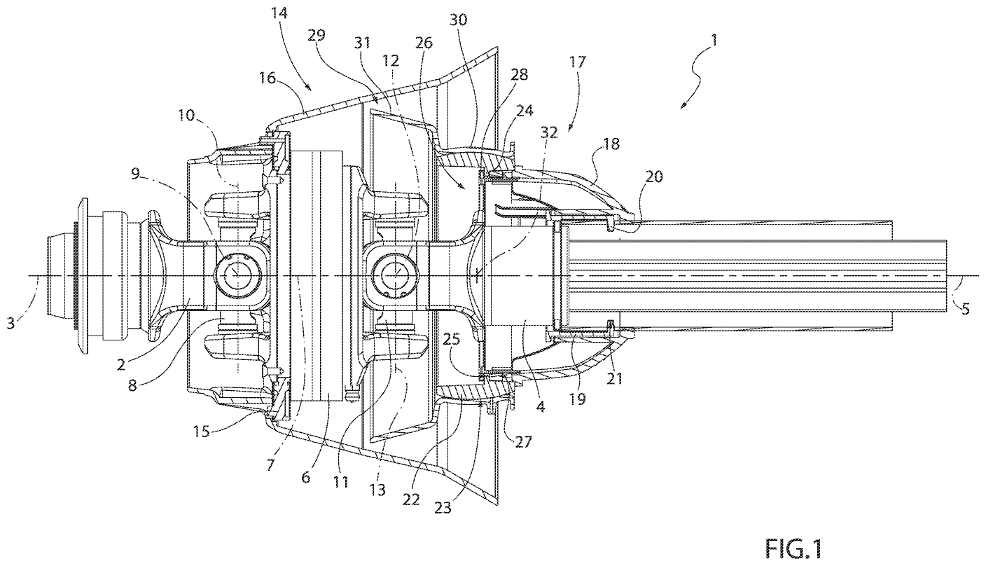

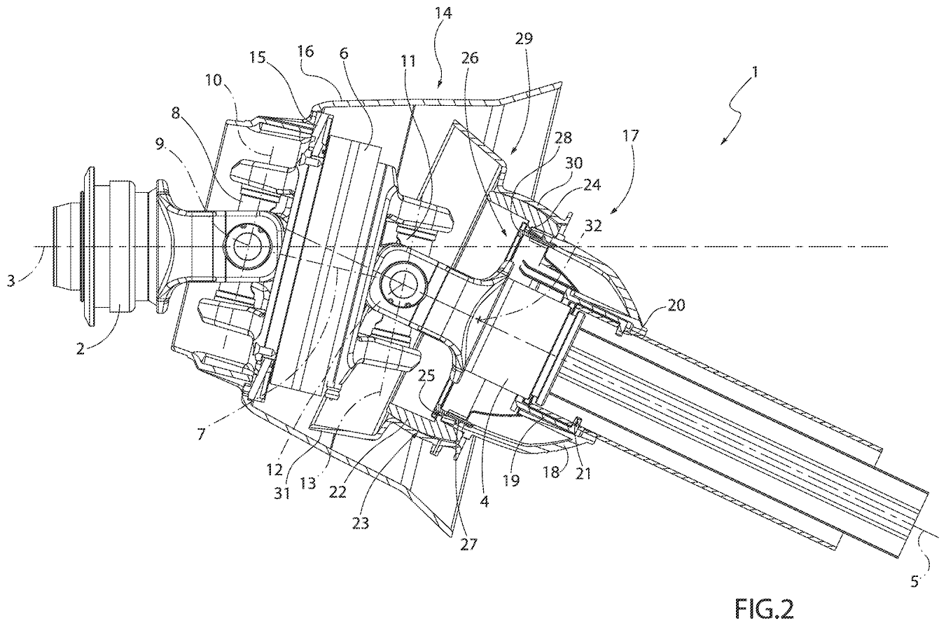

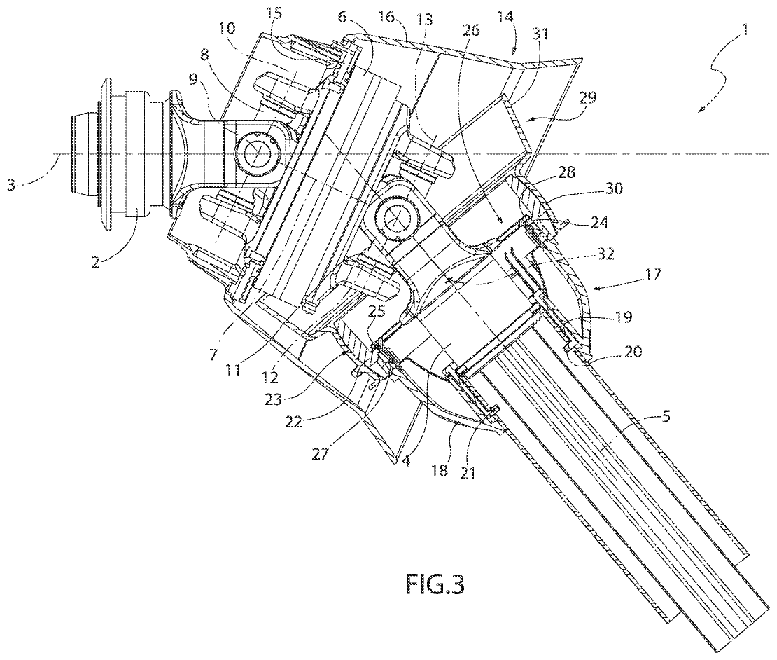

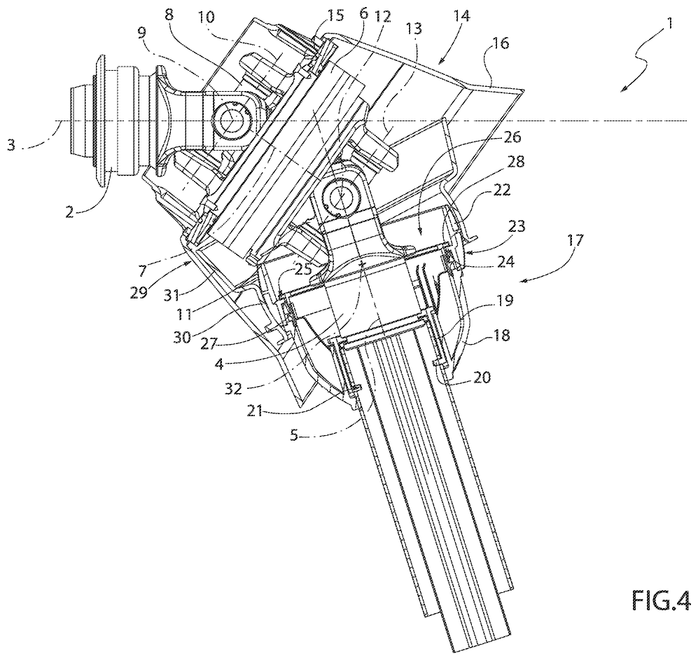

With reference to FIGS. 1, 2, 3 and 4, number 1 indicates, as a whole, a double Cardan joint, in particular to connect an agricultural equipment (which is not shown herein) to an agricultural machinery (which is not shown herein).

The joint 1 comprises a driving fork 2, which is designed to be connected to a power take-off (not shown) of the agricultural machinery (not shown) and is mounted so as to rotate around a longitudinal axis 3 of its; a driven fork 4, which is designed to be connected to the agricultural equipment (not shown) and is mounted so as to rotate around a longitudinal axis 5 of its; and a central body 6, which is interposed between the driving fork 2 and the driven fork 4 and is mounted so as to rotate around a longitudinal axis 7 of its.

The body 6 is connected to the driving fork 2 by means of a first cross shaft 8 in order to allow the body 6 and the driving fork 2 to rotate relative to one another around a rotation axis 9, which is orthogonal to the axis 3, and around a rotation axis 10, which is orthogonal to the axes 7 and 9.

The body 6 is further connected to the driven fork 4 by means of a second cross shaft 11 in order to allow the body 6 and the driven fork 4 to rotate relative to one another around a rotation axis 12, which is orthogonal to the axis 5, and around a rotation axis 13, which is orthogonal to the axes 7 and 12.

The joint 1 is further provided with a first protection device 14 comprising a limit stop ring 15, which extends around the body 6 coaxially to the axis 7, is engaged by the body 6 in a rotary manner, so as to allow the body 6 to rotate around the axis 7, and is moved by the body 6 around the axes 9, 10, 12 and 13.

The device 14 further comprises a cap 16, which is made of a rigid plastic material, has the shape of a truncated cone with a concavity facing the driven fork 4 and is locked on the ring 15.

The joint 1 is further provided with a second protection device 17 comprising a casing 18 with a tubular shape, which extends around the driven fork 4 coaxially to the axis 5, is engaged by the driven fork 4 in a rotary manner, so as to allow the driven fork 4 to rotate around the axis 5, and is moved by the driven fork 4 around the axes 12 and 13.

The casing 18 and the driven fork 4 are connected to one another by a coupling sleeve 19, which is locked inside the casing 18 through interference.

The sleeve 19 is coupled to the driven fork 4 in a rotary and axially fixed manner by means of an annular flange 20, which radially projects towards the inside of the sleeve 19 and is coupled in a snapping manner into a corresponding annular cavity 21 obtained on the driven fork 4.

The device 17 further comprises a support bearing 22, which is fitted onto a free end of the casing 18 coaxially to the axis 5, axially projects from the casing 18 and is delimited by an outer surface 23 with a spherical shape.

The bearing 22 further has an annular flange 24, which is obtained in the area of an intermediate point of the bearing 22, radially projects from an inner surface of the bearing 22 and is in contact with an end face 25 of the casing 18.

The flange 24 and, hence, the bearing 22 are axially and angularly locked against the face 25 of the casing 18 by a locking plug 26 with a cylindrical shape comprising a stem 27, which is locked inside the casing 18 through interference, and a head 28, which axially faces the flange 24.

The device 17 finally comprises a cap 29, which extends inside the cap 16 and is made of a rigid plastic material.

The cap 29 has a first portion 30 with a spherical shape, which is coupled to the surface 23 of the bearing 22, and a second portion 31 with the shape of a truncated cone, which axially projects from the bearing 22 and has a concavity facing the cap 16.

The assembly defined by the casing 18, by the sleeve 19, by the bearing 22, by the plug 26 and by the cap 29 is moved by the driven fork 4 around the axes 12 and 13.

In use, when the portion 31 of the cap 29 comes into contact with the limit stop ring 15, the coupling between the surface 23 of the bearing 22 and the portion 30 of the cap 29 allows the cap 29 to rotate, relative to the bearing 22 and, hence, the driven fork 4, around a rotation axis 32, which is transverse, in particular orthogonal, to the axis 5.

As a consequence, the space defined between the caps 16 and 29 is relatively small and, at most, is equal to a threshold value, in particular a threshold value defined by standards, regardless of the position of the body 6 around the axis 9 and of the driven fork 4 around the axis 12.

1. A double Cardan joint comprising: a driving fork, which is mounted so as to rotate around a longitudinal axis of its; a driven fork, which is mounted so as to rotate around a longitudinal axis of its; a central body, which is mounted so as to rotate around a longitudinal axis of its; a first cross shaft to connect the driving fork and the central body to one another; a second cross shaft to connect the driven fork and the central body to one another; a first protection cap connected to the central body; and a second protection cap connected to the driven fork; wherein the second protection cap is coupled to the driven fork in a rotary manner so as to rotate, relative to the driven fork, around a rotation axis, which is transverse, in particular orthogonal, to the longitudinal axis of the driven fork.

2. The double Cardan joint according to claim 1 further comprising a spherical bearing, which is engaged by the driven fork in a rotary manner, so as to allow the driven fork to rotate around its own longitudinal axis, and by the second protection cap in a rotary manner, so as to allow the second protection cap to rotate around said rotation axis.

3. The double Cardan joint according to claim 2 further comprising a protection casing, which extends around the driven fork, is mounted in succession to the second protection cap and is engaged by the driven fork in a rotary manner; the spherical bearing being coupled to the protection casing in an angularly and axially fixed manner.

4. The double Cardan joint according to claim 3 further comprising a locking ring to lock the spherical bearing on the protection casing.

5. The double Cardan joint according to claim 4 wherein the locking ring is locked on the protection casing through interference.

6. The double Cardan joint according to claim 4 wherein the spherical bearing is fitted on the protection casing and has a coupling flange, which projects from an inner surface of the spherical bearing and is axially locked by the locking ring against a free end of the protection casing.

7. The double Cardan joint according to claim 1 wherein the central body is engaged through the first protection cap in a rotary manner so as to rotate around its own longitudinal axis and the driven fork is engaged through the second protection cap in a rotary manner so as to rotate around its own longitudinal axis.

8. The double Cardan joint according to claim 1 further comprising a limit stop ring, which extends around the central body, is engaged by the central body in a rotary manner and is configured to stop the movement of the second protection cap around said rotation axis.

9. The double Cardan joint according to claim 8, wherein the first protection cap is mounted on the limit stop ring.

10. The double Cardan joint according to claim 1 wherein said first and second protection cap are made of a rigid plastic material.
